(19) United States
(12) Patent Application Publication
(10) Pub. No.: US 2009/0276818 A1
(43) Pub. Date: Nov. 5, 2009

(54) METHOD FOR PROVIDING IPTV SERVICE AND INTERNET BROADCASTING SYSTEM THEREFOR

(75) Inventors: Ji-Eun KEUM, Suwon-si (KR); Sung-Oh Hwang, Yongin-si (KR); Bo-Sun Jung, Seongnam-si (KR); Jun-Hyung Kim, Suwon-si (KR); Jong-Hyo Lee, Pyeongtaek-si (KR)

Correspondence Address: THE FARRELL LAW FIRM, LLP, 290 Broadhollow Road, Suite 210E, Melville, NY, 11747, US

(73) Assignee: SAMSUNG ELECTRONICS CO., LTD., Suwon-si (KR)

(21) Appl. No.: 12/434,183

(22) Filed: May 1, 2009

(30) Foreign Application Priority Data
May 2, 2008 (KR) 10-2008-0041337

(51) Int. Cl. H04N 7/173

(52) U.S. Cl. 725/105

(57) ABSTRACT

An apparatus and method for providing preferred contents to a user in an Internet broadcasting system that provides a broadcast service using an Internet data transport protocol. A user terminal sends a request for a broadcast service to a service provider. The user terminal receives an authentication key from the service provider, and delivers the authentication key to a third display terminal in which a user of the user terminal is not registered. The third display terminal delivers the authentication key and connection information of the third display terminal to the service provider. The service provider authenticates the third display terminal. The user terminal transmits information selected by the user to the service provider, which transmits broadcast service data related to the selected information to the third display terminal for being displayed.

### PRIORITY

This application claims priority under 35 U.S.C. §119(a) to a Korean Patent Application filed in the Korean Intellectual Property Office on May 2, 2008 and assigned Serial No. 10-2008-0041337, the entire disclosure of which is incorporated herein by reference.

### BACKGROUND OF THE INVENTION

1. Field of the Invention

The present invention relates generally to an Internet Protocol (IP) broadcasting system that supports broadcast services using an Internet data transport protocol, and more particularly, to a method and system for offering only preferred contents of users in an IP broadcasting system.

2. Description of the Related Art

The convergence of broadcasting and communication has created a new business model, which has high marketability and attracts attention as a next-generation market leading technology. In particular, Internet Protocol (IP) broadcast service (also known as Internet Protocol TeleVision (IPTV) service) technology, which is major aspect in the broadcasting-communication convergence, is a technology that provides services designed by remixing or combining pre-existing TeleVision (TV), voice, and data technologies into one technology, and also supports interactivity of these services, enabling creation of new business models and services. Unlike the conventional technology, which provides specialized services in existing environments where the types of serviceable terminals are limited, IPTV technology may provide services to all types of fixed terminals (e.g., set-top boxes, Personal Computers, TVs, etc.) and mobile terminals (e.g., mobile phones, Personal Digital Assistants (PDAs), etc.) over wired/wireless networks and/or broadcasting networks, making it possible to offer and apply the same services in these various environments and to develop a variety of new services by considering diverse environments.

FIG. 1 illustrates an entire domain and a value chain related to IPTV.

Referring to FIG. 1, the entire domain associated with IPTV includes a consumer domain 1101, a network provider domain 1102, a platform provider domain 1103, an IPTV service provider domain 1104, and a content provider domain 1105, in order to offer IPTV services to a user 1100.

The consumer domain 1101, i.e., a domain consuming IPTV services, often includes at least one terminal for receiving and consuming services, and a network (e.g., a home network) including several terminals. The terminals may include a set-top box, and also portable terminals supporting wireless environments, such as mobile phones and/or PDAs.

The network provider domain 1102 connects the user 1100 to a platform or service provider, and delivers various services and contents to the user 1100. A transmission system of the network provider domain 1102 may support diverse wired/wireless and broadcast transmission technologies, and commonly includes an access network and a core or backbone network.

The platform provider domain 1103 provides common services, such as user authentication and charging services, to an IPTV service provider.

The IPTV service provider domain 1104, i.e., a domain for providing IPTV services to the consumer domain 1101, receives content provided from a content provider and packages the content into a service, which is then provided to the consumer domain 1101.

The content provider domain 1105 stores content or content assets and also holds the copyrights thereof. Various IPTV services as well as scheduled content services and content-on-demand services may be provided in the above-described five domains 1101 through 1105.

Additionally, four functions or units 1106-1109 make up one value chain to provide such services. More specifically, a content production unit 1109, included in the content provider domain 1105, actually produces and edits the content. A content aggregation unit 1108, included in the IPTV service provider domain 1104, receives content provided from various content providers and aggregates the received content into diverse services. A content delivery unit 1107, which accesses both the platform provider domain 1103 and the network provider domain 1102, delivers the aggregated content provided from the IPTV service provider to the consumer domain 1101. A content reconstitution unit 1106, included in the consumer domain 1101, converts the provided content into a format viewable by a user.

IPTV services are often classified into a managed model and an unmanaged model (Open Internet) according to whether they provide Quality-of-Service (QoS). In the managed model, the service provider operates the platform provider domain 1103, the network provider domain 1102, and the IPTV service provider domain 1104 in an integrated manner. In the unmanaged model, as the service provider and the network provider are separated. The service provider, which belongs to the IPTV service provider domain 1104, puts the content delivery under charge of other network providers (i.e., the network provider domain 1102 and the platform provider domain 1103).

FIG. 2 illustrates a conventional flow diagram in which a user receives content provided from a service provider and then utilizes the received content.

A service provider 1201, as described above, may operate in any one of the managed model and the unmanaged model. Herein below, the service provider 1201 is assumed to operate in the managed model. Therefore, for convenience, a network provider is not illustrated in FIG. 2.

Referring to FIG. 2, a content provider 1200 creates content and detailed information on the content (hereinafter referred to as “content information”) in step 1204, and provides the created content and content information to the service provider 1201 in step 1205.

Upon receiving the content and content information, the service provider 1201 creates an Electronic Program Guide (EPG) using the provided content and content information in step 1206. The EPG may include detailed information, purchase methods, access methods, etc., for the services and contents provided by the service provider 1201.

In step 1207, the service provider 1201 delivers the EPG to a set-top box 1202. Upon receiving the EPG, the set-top box 1202 processes the EPG and provides the processed information for the EPG to a TV (or other display device) 1203 in step 1208, thereby displaying the information so that a user 1100 may look at it.

The user 1100 selects desired content referring to the EPG displayed on the TV 1203 in step 1209, and the TV 1203 forwards a request message for the selected content to the service provider 1201 via the set-top box 1202 in step 1210.

In step 1211, the selected content is delivered to the user 1100. Herein, the content may be delivered in various ways according to a policy of the service provider 1201. For example, the service provider 1201 may directly deliver the content stored therein to the user 1100, or deliver the content received from the content provider 1200 to the user 1100, according to its service policy. A transmission mode and a content type can also be classified into, for example, streaming/downloading modes and real-time/non-real-time types. In step 1212, the delivered content is displayed on the TV 1203, and the user 1100 may watch the displayed content.

Using the conventional system described above, users may have difficulty in searching for desired channels in an Internet broadcasting system that supports a large number of channels over an IP network. Therefore, there is a long-felt need for a method and apparatus for providing a user with only the contents desired by the user, without an inconveniently having to search for the desired content, identify a channel associated with the content, and then switch to the channel in an Internet broadcasting system.

### SUMMARY OF THE INVENTION

Accordingly, the present invention has been designed to address at least the above-described problems and/or disadvantages occurring in the prior art and to provide at least the advantages described below. An aspect of the present invention provides a method and system for allowing a user to receive only preferred content in an Internet broadcasting system.

Another aspect of the present invention provides a method and system that enable a user to receive IPTV services to which the user has subscribed, using a third display terminal, which is not registered for the user, in an Internet broadcasting system.

In accordance with an aspect of the present invention, a method is provided for providing an Internet Protocol TeleVision (IPTV) service in an Internet broadcasting system. A user terminal sends a request for a broadcast service to a service provider. The user terminal receives an authentication key from the service provider, and delivers the authentication key to a third display terminal in which a user of the user terminal is not registered. The third display terminal delivers the authentication key and connection information of the third display terminal to the service provider. The service provider performs authentication on the third display terminal, and delivers the authentication result to the third display terminal. The user terminal transmits information selected by the user to the service provider. The service provider transmits broadcast service data related to the selected information to the third display terminal. The third display terminal displays the transmitted broadcast service data.

In accordance with another aspect of the present invention, an Internet broadcasting system is provided for providing an Internet Protocol TeleVision (IPTV) service. A user terminal communicates with a service provider in which the user terminal is registered, and the service provider provides the IPTV service to a user of the user terminal that subscribed to the IPTV service. A third display terminal, which is not registered in the service provider, receives an authentication key with the service provider from the user terminal, performs authentication with the service provider using the authentication key, receives data associated with an IPTV service requested by the user from the service provider, and displays the received data.

### BRIEF DESCRIPTION OF THE DRAWINGS

The above and other aspects, features, and advantages of certain embodiments of the present invention will be more apparent from the following description taken in conjunction with the accompanying drawings, in which:

FIG. 1 illustrates a domain structure and a value chain for IPTV services;

FIG. 2 illustrates a conventional flow diagram in which a user receives content provided from a service provider and then utilizes the received content;

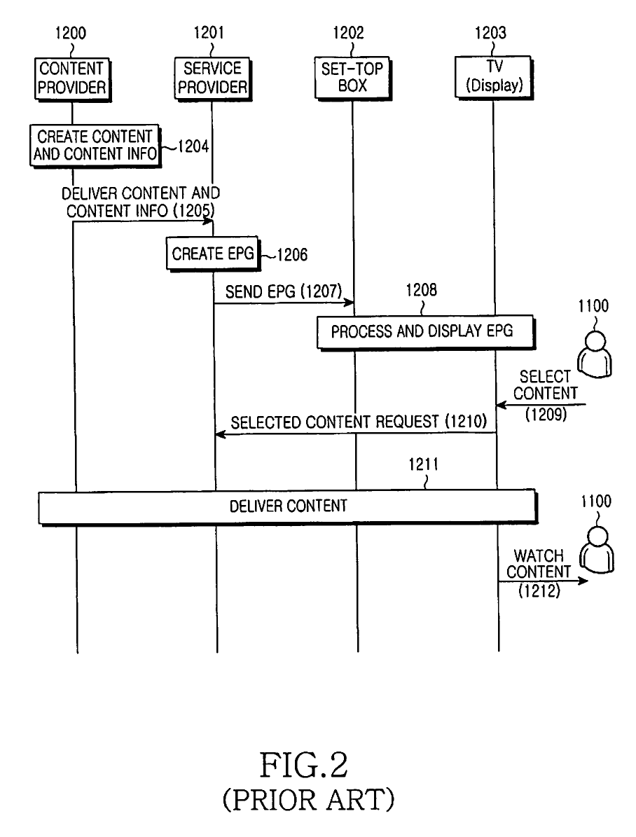

FIG. 3 illustrates a structure of a network apparatus according to an embodiment of the present invention;

FIG. 4 illustrates a procedure for providing an IPTV service according to an embodiment of the present invention; and

FIG. 5 illustrates a procedure for providing an IPTV service according to another embodiment of the present invention.

### DETAILED DESCRIPTION OF EMBODIMENTS OF THE PRESENT INVENTION

Herein below, various embodiments of the present invention are described in detail with reference to the accompanying drawings. The same or similar components may be designated by the same or similar references numerals although they are illustrated in different drawings. Also, detailed descriptions of constructions or processes known in the art may be omitted to avoid obscuring the subject matter of the present invention.

In the following description, the embodiments of the present invention will be described using names of entities defined in 3^{rd} Generation Partnership Project (3GPP), which is a standard for asynchronous mobile communication, or Open IPTV Forum (OIPF), which is a standard for Internet Protocol TV, for convenience. However, these names are not intended to limit the scope of the present invention, but are merely used as an example, and the present invention may be applied to any system having a similar technical background.

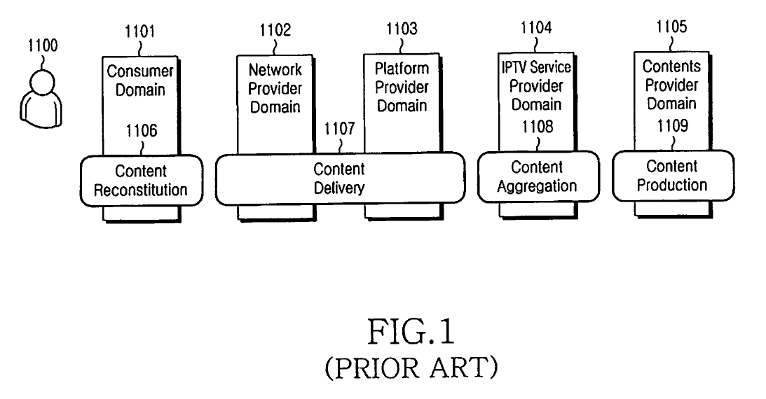

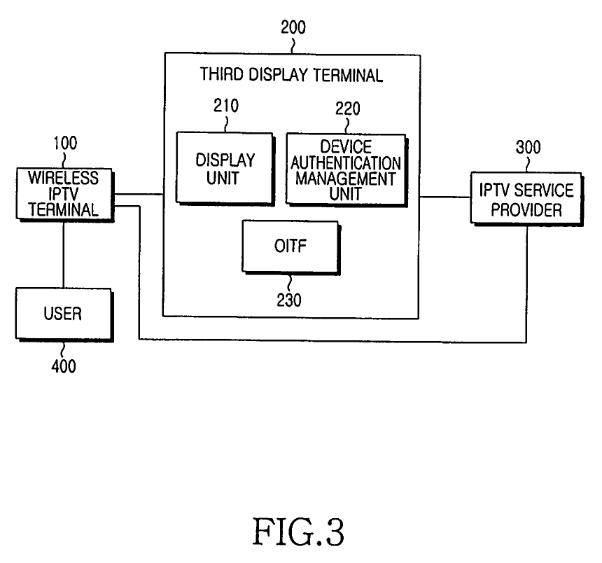

FIG. 3 illustrates a structure of a network apparatus according to an embodiment of the present invention. More specifically, the network apparatus of FIG. 3 includes logical entities that are added to the existing IPTV network apparatus illustrated in FIG. 1.

Referring to FIG. 3, a user 400, e.g., a subscriber to an IPTV service, carries a wireless IPTV terminal 100. The wireless IPTV terminal 100 is registered in an IPTV service provider 300 (hereinafter referred to as a “service provider” for short). The service provider 300 communicates with the wireless IPTV terminal 100 using a wireless communication medium. The network also includes a third display terminal 200, e.g., a monitor in a public place or another display device that is not registered for the user 400.

The third display terminal 200 includes a display unit 210, a device authentication management unit 220, and an Open IPTV Forum (OIPF) Unit 230. The display unit 210 displays multimedia data so that the user 400 may view the IPTV services. The device authentication management unit 220 stores and protects temporary encryption keys (hereinafter referred to as “temporary keys” for short), which are used for authentication with the service provider 300. The OIPF UNIT 230 serves as an IPTV terminal as defined in OIPF.

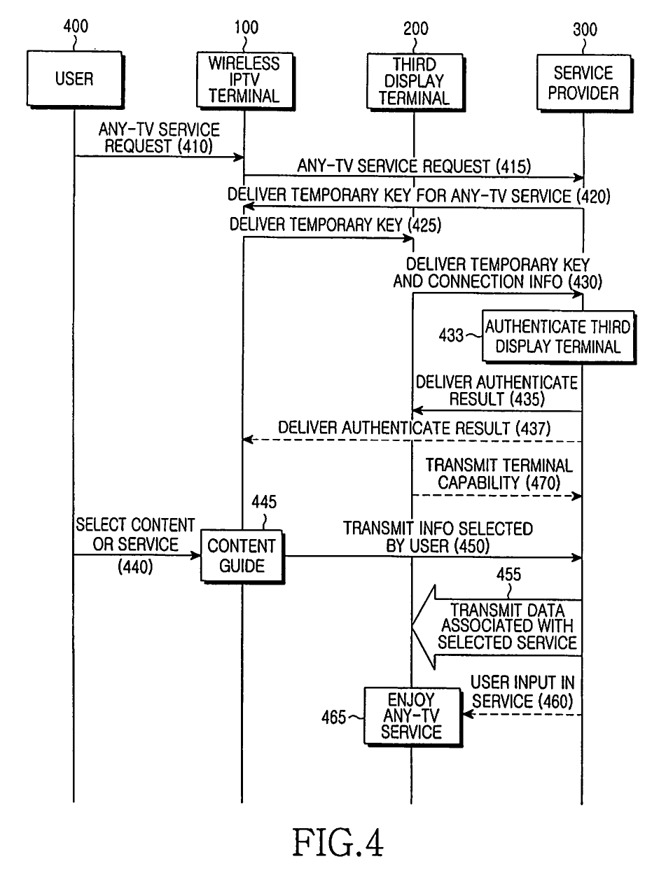

FIG. 4 illustrates a procedure for providing an IPTV service according to an embodiment of the present invention.

Referring to FIG. 4, in step 410, the user 400 sends, to the wireless IPTV terminal 100, a request for a specific service (e.g., Any TV service with which the user 400 may watch or enjoy an IPTV service using the wireless IPTV terminal 100 and the third display terminal 200.

In step 415, the wireless IPTV terminal 100 forwards the Any TV service request message to the service provider 300. For example, the Any TV service request message may use an IP Multimedia Subsystem Session Initiation Protocol (IMS SIP) defined in European Telecommunications Standards Institute (ETSI), and a “SIP Request Message” defined by a related standard may be used as the request message. A “Request Universal Resource Identifier (URI)” includes a Public Service Identifier (PSI) of a server that provides broadcast services according to an embodiment of the present invention.

Table 1 below shows an example of the SIP Request Message.

TABLE 1

```
  MESSAGE sip:user@domain.com SIP/2.0
    Max-Forwards: 70
    From: sip:user1@domain.com;tag=49583
    To: sip:AnyTV@domain.com
    Call-ID: asd88asd77a@1.2.3.4
    CSeq: 1 MESSAGE
    Event: IPTV
Content-Type: Application/AnyTV+Xml
```

In order to provide the Any TV service requested through the Any TV service request message to the user 400, the service provider 300 should define an Any TV service function block, which is based on an IMS network, and should be able to provide the service to the user 400 using an IMS as a pertinent PSI is allocated. Therefore, in step 420, the service provider 300 delivers a temporary key used for authentication of the third display terminal 200 to the wireless IPTV terminal 100. The temporary key may include information about a lifetime of a security key, a right range of the security key, etc. The service provider 300 may provide the user the right to enter information while watching an IPTV service on the third display terminal 200 or may merely provide the user may the right to only watch the IPTV service. Therefore, the service provider 300 may create an encryption key such that it includes the right range information, and deliver the encryption key.

Upon receiving the temporary key, the wireless IPTV terminal 100 forwards the received temporary key to the third display terminal 200 in step 425.

In step 430, the third display terminal 200 delivers connection information including its own IP address (or the like) to the service provider 300, along with the received temporary key.

In step 433, the service provider 300 authenticates the third display terminal 200 by comparing the temporary key received from the third display terminal 200 with its encryption key.

In step 435, the service provider 300 delivers the authentication result to the third display terminal 200. In step 437, the service provider 300 delivers the same authentication result to the wireless IPTV terminal 100. However, step 437 may be omitted if the authentication result is exchangeable between the wireless IPTV terminal 100 and the third display terminal 200.

In step 470, the third display terminal 200, which has received the authentication result, transmits its capability information related to the IPTV service to the service provider 300. Step 470 can also be omitted according to implementation.

In step 440, the user 400 selects content or a specific service using a content guide 445 that was downloaded and stored in the wireless IPTV terminal 100 in advance. The information selected by the user 400 is transmitted to the service provider 300 in step 450. Steps 440 and 450 may be replaced with an operation in which the user 400 directly accesses the service provider 300 and selects the content or service.

In step 455, the service provider 300 transmits data related to the service selected by the user 400 to the third display terminal 200.

In step 465, the user 400 enjoys the Any TV service displayed on the third display terminal 200.

Additionally, in step 460, the user 400 may be allowed to enter information onto the third display terminal 200 by means of the service provider 300 while enjoying the IPTV service, based on the right range defined by the temporary key delivered in step 420.

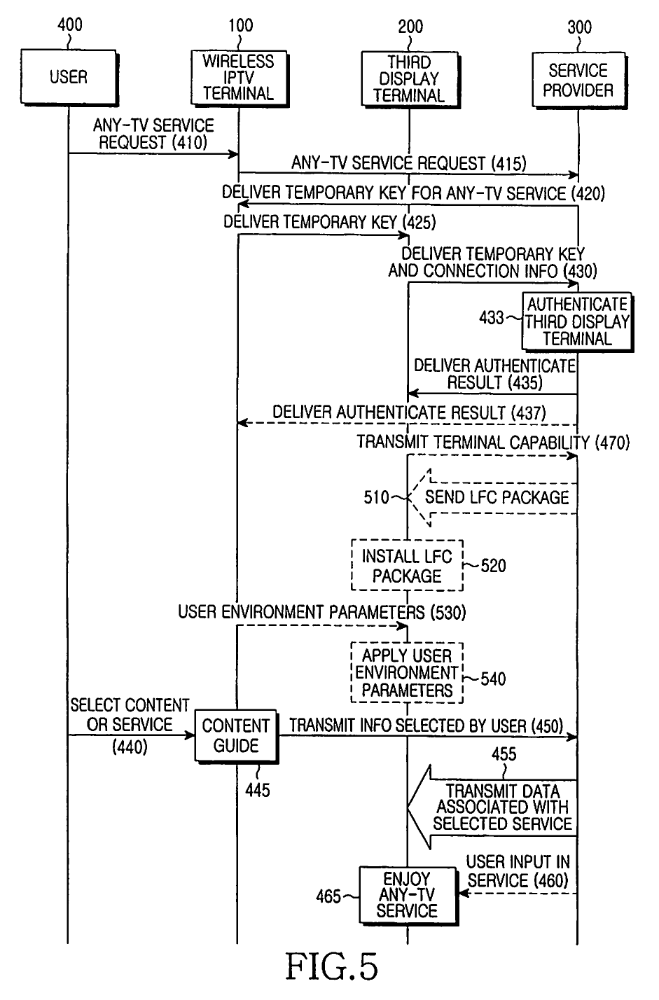

FIG. 5 illustrates a procedure for providing an IPTV service according to another embodiment of the present invention.

Referring to FIG. 5, the user 400 may move the IPTV service to third display, as illustrated in FIG. 4, and may also move a service environment to enjoy it on the third display terminal 200. Accordingly, the IPTV service procedure illustrates in FIG. 5 is equivalent to that of FIG. 4, except that FIG. 5 further includes steps 510, 520, 530 and 540. Therefore, a repeated description of the steps described in conjunction with FIG. 4 is omitted below.

Referring to FIG. 5, after the authentication result at the service provider 300 is delivered to the third display terminal 200 and the wireless IPTV terminal 100, in step 510, the service provider 300 transmits, to the third display terminal 200, a Look and Feel (LFC) package including user environment parameters adapted to the user 400. The user environment parameters may include, for example, a background screen, a ring tone, a menu location, configuration information, etc. In step 520, the third display terminal 200 installs the received LFC package. Alternatively, with steps 510 and 520 being excluded, the wireless IPTV terminal 100 may directly transmit designated user environment parameters to the third display terminal 200 in step 530. Then, the third display terminal 200 applies the received user environment parameters in step 540. In this manner, the user 400 may move the IPTV service and also its service environment to enjoy it on the third display terminal 200.

As is apparent from the foregoing description, the present invention enables a user to view an IPTV service to which the user subscribed, using a third display terminal that includes the user's environment information. Therefore, the user may conveniently receive the IPTV service, regardless of the user's location, and the service provider is provided with another billable service to provide.

The above-described embodiments of the present invention can also be embodied as computer-readable codes on a computer-readable recording medium. The computer-readable recording medium is any data storage device that can store data that can thereafter be read by a computer system. Examples of the computer-readable recording medium include, but are not limited to, read-only memory (ROM), random-access memory (RAM), CD-ROMs, magnetic tapes, floppy disks, optical data storage devices, and carrier waves (such as data transmission through the Internet via wired or wireless transmission paths). The computer-readable recording medium can also be distributed over network-coupled computer systems so that the computer-readable code is stored and executed in a distributed fashion. Also, function programs, codes, and code segments for accomplishing the present invention can be easily construed as within the scope of the invention by programmers skilled in the art to which the present invention pertains.

While the present invention has been shown and described with reference to certain embodiments thereof, it will be understood by those skilled in the art that various changes in form and details may be made therein without departing from the spirit and scope of the present invention as defined by the appended claims and their equivalents.

What is claimed is:

1. A method for providing an Internet Protocol TeleVision (IPTV) service in an Internet broadcasting system, the method comprising:
sending, by a user terminal, a request for a broadcast service to a service provider;
receiving, by the user terminal, an authentication key from the service provider;
sending the authentication key to a third display terminal in which a user of the user terminal is not registered;
sending, by the third display terminal, the authentication key and connection information of the third display terminal to the service provider;
authenticating, by the service provider, the third display terminal;
sending, by the service provider, an authentication result to the third display terminal;
transmitting, by the user terminal, broadcast service information selected by the user to the service provider;
transmitting, by the service provider, broadcast service data related to the selected broadcast service information to the third display terminal; and
displaying, by the third display terminal, the transmitted broadcast service data.

2. The method of claim 1, further comprising:
transmitting, by the service provider, user environment parameters to the third display terminal; and
installing, by the third display terminal, the transmitted user environment parameters.

3. The method of claim 2, wherein the user environment parameters include at least one of a background screen, a ring tone, a menu location, and configuration information.

4. The method of claim 1, further comprising:
transmitting, by the user terminal, user environment parameters to the third display terminal; and
installing, by the third display terminal, the transmitted user environment parameters.

5. The method of claim 4, wherein the user environment parameters include at least one of a background screen, a ring tone, a menu location, and configuration information.

6. The method of claim 1, further comprising:
sending the authentication result to the user terminal.

7. The method of claim 1, further comprising:
sending, by the third display terminal, capability information related to an IPTV service to the service provider.

8. An Internet broadcasting system for providing an Internet Protocol TeleVision (IPTV) service, comprising:
a user terminal that is registered in a service provider, for communicating with the service provider that provides the IPTV service and providing the IPTV service to a user of the user terminal; and
a third display terminal that is not registered in the service provider, for receiving an authentication key with the service provider from the user terminal, authenticating with the service provider using the authentication key, receiving data associated with an IPTV service requested by the user from the service provider, and displaying the received data.

9. The Internet broadcasting system of claim 8, wherein the third display terminal receives user environment parameters from the service provider, and applies the received user environment parameters.

10. The Internet broadcasting system of claim 9, wherein the user environment parameters comprise at least one of:
a background screen;
a ring tone;
a menu location; and
configuration information.

11. The Internet broadcasting system of claim 8, wherein the third display terminal receives user environment parameters from the user terminal and applies the received user environment parameters.

12. The Internet broadcasting system of claim 11, wherein the user environment parameters comprise at least one of:
a background screen;
a ring tone;
a menu location; and
configuration information.

13. The Internet broadcasting system of claim 8, wherein the third display terminal comprises:
a display unit for displaying the received data associated with the IPTV service;
a device authentication management unit for authenticating with the service provider using the authentication key; and
an IPTV service terminal.

14. The Internet broadcasting system of claim 13, wherein the IPTV service terminal comprises:
an Open IPTV Forum (OIPF) Unit.
